(19) United States
(12) Patent Application Publication
(10) Pub. No.: US 2018/0150877 A1
(43) Pub. Date: May 31, 2018

(54) 3RD PARTY REQUEST-BLOCKING BYPASS LAYER

(71) Applicant: CHAMELEONX LTD., Tel Aviv (IL)

(72) Inventors: Maor Hod, Jerusalem (IL); Shay Elkana, Givatayim (IL)

(21) Appl. No.: 15/572,211

(22) PCT Filed: May 25, 2016
(86) PCT No.: PCT/IB2016/053046

§ 371 Date: Nov. 7, 2017

Related U.S. Application Data
(60) Provisional application No. 62/166,099, filed on May 25, 2015.
(60) Provisional application No. 62/302,211, filed on Mar. 2, 2016.

(51) Int. Cl. G06Q 30/02; H04L 29/08

(52) U.S. Cl. CPC G06Q 30/0257; H04L 67/34; G06Q 2220/10; G06Q 30/0277; H04L 67/025

(57) ABSTRACT

A system and method for bypassing 3rd party request-blocking, comprising: at least one system server running a server application; at least one asset serving system communicating with said system server over the internet; a system application running on an application server, said application server communicating over the internet with said system server; at least one publisher's content server communicating over the internet with said system application; and a plurality of user communication devices communicating over the Internet with the system application, said server application configured to continuously create and update a block bypass package comprising scripts comprising secured formations for said at least one publisher's web pages, said system application configured to inject said scripts into said at least one publisher's web pages and to selectively redirect asset requests from said plurality of user communication devices' browsers to said at least one system server or to said at least one publisher's content server.

### FIELD OF THE INVENTION

The present invention relates generally to on-line asset blocking, and particularly to methods and systems for detecting and preventing asset blocking.

### CROSS-REFERENCE TO RELATED PATENT APPLICATIONS

This patent application claims priority from and is related to U.S. Provisional Patent Application Ser. No. 62/166,099, filed May 25, 2015 and U.S. Provisional Patent Application Ser. No. 62/302,211 filed Mar. 2, 2016, these U.S. Provisional Patent Applications incorporated by reference in their entirety herein.

### BACKGROUND

Recent figures show that on average, 15%-30% of ads are blocked by abuse advertising software, which causes a substantial loss for publishers whose business models rely on advertising.

In order to implement a third-party ad code into a publisher's webpage, under the conventional ad serving method, a webmaster inserts a third-party ad network client-side scripts/code (usually HTML code/iframe/JavaScript etc). Upon request, the necessary ad content (images, flash videos, text, etc.) is being sent to the user's computer by his ad network vendor/sell-side platform (SSP)/ad exchange etc. through its ad serving web server (or servers).

The user's web browser executes the script and subsequently displays the ad content including any visible output from the script. In addition, the client-side ads scripts also contains instructions for the browser to follow in response to certain user actions, (e.g., clicking a button, URL link etc.).

FIG. 1 is a schematic representation of a prior art system working according to this scheme, comprising a publisher's server 120, an ad-server 130 and a user's browser 140.

By using this approach, some abuse advertising software which is installed in a browser, such as ad filtering or ad blocking software (e.g. Adblock, Adblock Plus, uBlock etc.) and/or some Network/infrastructure level content/advertisement filters (e.g. Shine), causes at least one of the following results:

Removes advertising content from the client webpage by:

i. Allowing users to prevent page specific elements, such as (and mainly) advertisements, from being displayed.

ii. Preventing communication between the end user and the ad networks ads servers i.e. “Adblock Firewall”. By using this method the abuse advertising software prevents specific asset and/or webpage from loading (via browser request, redirect, or upon user clicking on an advertisement link), by blocking the Internet communication protocols (e.g. HTTP) requests' advertisements destination according to filter list. The abuse advertising software uses filters in order to determine whether an element should or should not be allowed based on the element's properties, mainly based on element source URL.

The Adblock Firewall applies filter rules in order to determine whether a page's URL request should be allowed; if the page's URL was found as not allowed, the Adblock Firewall blocks the Internet communication protocols (e.g. HTTP) request from sending to the ad serving server (see example in FIG. 2). Alternatively the Ad blocker may be implemented in the network level, e.g. on a router (personal or organizational) (see example in FIG. 2A).

A filter list enables auto URLs blocking for any URL which is directly from a commonly known third-party ad server, such as Google Ad Service (googleadservices.com).

Abuse advertising software filter list (e.g. EasyList, FilterList etc.) is a list of rules some of which are based on regular expressions, that allows abuse advertising software to remove advertisements from webpages, including frames, images, divs and objects. A filter usually includes some form of regular expression which is the basis of countless combinations of potential regular expressions. For example:
Any element which contains “not allowed” syntax or attributes such as *banner*, *ad* or common IAB-standard (Interactive Advertising Bureau) sizes (e.g. 728×90) will be blocked by the abuse advertising software.
The filter ad*banner.gif| will be translated into the regular expression /ad.*banner\.gif$/ and will block any resource of the form Ad and/or Banner.
   Besides translating filters into regular expressions Abuse advertising software also tries to extract text information from them. What it needs is a unique string of characters (a “shortcut”) that must be present in every address matched by the filter.
In addition, any element/advertisement source/URL/domain name/which is suspected as serving advertisements will be block, including any element which is served from a commonly known third-party ad server (such as Google AdSense).
   Ad blocking is being preformed on several levels:
Internet service provider level (cable Internet providers, mobile network operator);
Companies' IT and network; Local network firewall for online advertisements.
Virtual private network (VPN) ad blocker which prevents known ad servers from being loaded on the user device.
Browser extensions/or Mobile Application for the common browsers and mobile operation systems (such as Google Chrome, Apple Safari, Mozilla Firefox, Opera and Android and apple's IOS).

### SUMMARY

According to an aspect of the invention there is provided a system for bypassing 3^{rd} party request-blocking, comprising: at least one system server running a server application; at least one asset serving system communicating with said system server over the internet; a system application running on an application server, said application server communicating over the internet with said system server; at least one publisher's content server communicating over the internet with said system application; and a plurality of user communication devices communicating over the Internet with the system application, said server application configured to continuously create and update a block bypass package comprising scripts comprising secured formations for said at least one publisher's web pages, said system application configured to inject said scripts into said at least one publisher's web pages and to selectively redirect asset requests from said plurality of user communication devices' browsers to said at least one system server or to said at least one publisher's content server.

The secured formations may represent assets structures of said at least one publisher's website.

The secured formations may comprise at least one of encrypted messages, scrambled messages and cloaked messages.

The scripts may further comprise tests configured to detect the presence of 3^{rd} party request-blocking software in at least one of a user communication device, a user's browser and a user's network.

The injected scripts may comprise tags configured to send secured formation asset requests and receive instructions for creating said asset.

The application server may be deployed at a CDN (Content Delivery Network) POP (Point Of Presence) servers.

The application server may reside between a CDN and said at least one publisher's content server.

The application server may reside on a hosting level of said at least one publisher's content server.

The application server may reside between said at least one publisher's content server and said plurality of user communication devices.

According to another aspect of the present invention there is provided a method of bypassing 3^{rd} party request-blocking, comprising: providing at least one system server running a server application; at least one 3rd party asset serving system communicating with said system server over the internet; a system application running on an application server, said application server communicating over the internet with said system server; and at least one publisher's content server communicating over the internet with said system application; continuously creating and updating by said server application a block bypass package for said at least one publisher's website, said block bypass package comprising encryption keys and scripts comprising secured formations for said at least one publisher's web pages, receiving by said system application a secured formation virtual asset request from a user's browser executing said at least one publisher's website; using said publisher's block bypass package to regenerate an original asset request from said secured formation virtual asset request; communicating said regenerated original asset request to a server; receiving from said server and analyzing by said server application said requested original asset; using said publisher's block bypass package to create a secured formation for said original asset; and returning said created secured formation to said user's browser.

According to another aspect of the present invention there is provided a method of bypassing 3^{rd} party request-blocking, comprising: providing at least one system server running a server application; at least one 3rd party asset serving system communicating with said system server over the internet; a system application running on an application server, said application server communicating over the internet with said system server; and at least one publisher's content server communicating over the internet with said system application; continuously creating and updating by said server application a block bypass package for said at least one publisher's website, said block bypass package comprising encryption keys and scripts comprising secured formations for said at least one publisher's web pages, receiving by said system application a physical asset request from a user's browser executing said at least one publisher's website; retrieving by said system application said physical asset from said at least one publisher's content server; and if said physical asset is an HTML (HyperText Markup Language) page, injecting scripts comprising secured formations for said at least one publisher's web pages to said HTML page.

Continuously creating and updating by said server application a block bypass package for said at least one publisher's website may comprise: analyzing up-to-date blocking lists; scanning and learning said at least one publisher's website; creating/updating secured formation for said at least one publisher's website; and creating a bypass script comprising at least one test for detecting 3^{rd} party request-blocking.

The method may further comprise creating tags scripts configured to execute a request for a secured formation asset.

The method may further comprise: receiving by a user's browser an HTML page from said system application, said HTML page comprising said bypass script; running said at least one test for detecting 3^{rd} party request-blocking; and if said at least one test detects 3^{rd} party request-blocking, running said tags scripts.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic representation of a prior art Ad serving system;

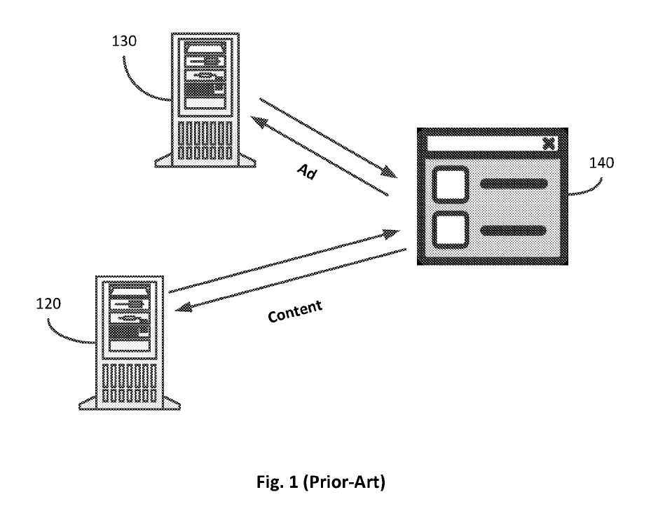

FIGS. 2 and 2A are schematic representation of prior art Ad serving systems comprising Ad blockers;

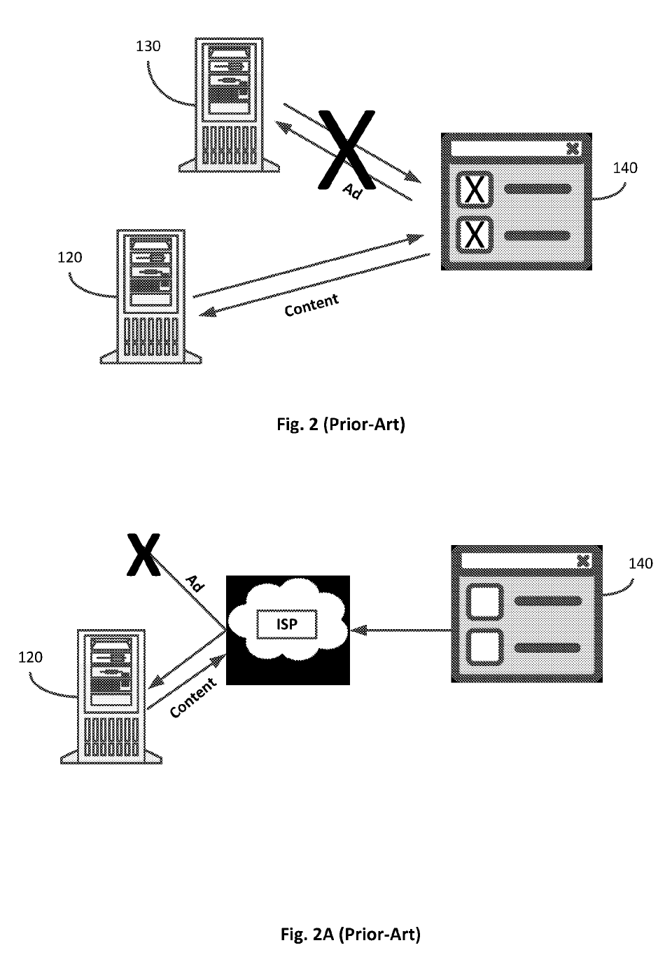

FIG. 3A represents exemplary structure patterns of a website's HTML elements and their nesting levels;

FIG. 3B represents exemplary structure patterns of a website's physical assets;

FIG. 4 is a schematic representation of the system components and connections according to embodiments of the present invention;

FIG. 5 is a flowchart showing part of the steps that taken by the server application running on the system server;

FIG. 5A is a block diagram showing the system modules performing the e-learn module;

FIG. 6 is a flowchart showing the steps taken by the scan & learn module;

FIG. 6A represents exemplary structure patterns of a website's physical assets;

FIG. 7A is a flowchart showing the steps taken by the system once a registered publisher's asset is requested by a user's browser;

FIG. 7B is a flowchart showing the steps taken by the Bypass Script contained in the HTML page once the user's browser loads the page received from the CX application;

FIG. 8 is a chart presenting another view of the data flow described in conjunction with FIGS. 7A and 7B; and

FIG. 9 shows exemplary non-limiting steps taken by the CX Tag script to create a secured formation asset.

### DETAILED DESCRIPTION OF EMBODIMENTS

The system and the method of the present invention provide an innovative approach to eliminating the effectiveness of online request blocking by abuse software (e.g. Adblock, Adblock Plus, uBlock etc.).

The present invention provides a new and innovative secured asset (e.g. Ad) serving platform. The unique solution combines a real-time preventative, detective and corrective approach which enables publishers to prevent asset blocking traffic. The cloud-based platform of the present invention is robust, scalable and fault-tolerant to ensure high performance.

The solution is designed to integrate seamlessly with the leading asset serving platforms and thereby allows publishers and networks to keep working with their existing infrastructure and business architecture.

### Entities Used by the System

1. Physical asset—An asset/element/file which is physically stored on the website's servers, e.g. image, HTML page, music, video, etc.

2. Virtual asset—A URL that leads to an asset in the website that does not physically exist in the website. The content returned to the browser asking for a virtual asset will actually originate from a 3^{rd} party outside the website (this is a kind of proxy address).

3. CX Secured virtual asset—A novel entity based on the following elements:
Structures, characteristics, behavior patterns and names of all the physical assets in the website.
The secured virtual asset's address is temporary and unique.
The secured virtual asset's name/address includes an encrypted and/or scrambled and/or cloaked message, based on the most appropriate structure of the website.

4. CX Tags/Invocation Code—Novel entities which are responsible for the Secured Asset Serving delivery & verification processes. The CX Tag serves as a secured communication channel between the user's Internet Client and the system's CX application, using secured virtual assets. The CX Tag is built by a dynamic algorithm which creates a unique secured formation system for each website, based on scanning and mapping all the physical assets in the website. The CX Tags are placed in the publisher's website using at least one of two modes:
a. By identifting asset server invocation codes.
b. By the publisher embedding the CX Tags directly on his webpage.

5. CX Encryption key—The CX encryption key is dynamic key which is required for Encrypting/Decrypting messages within secured virtual assets of a website. The CX encryption keys may be changed based on at least one of the following: session ID, cookie value, an IP address, or time limit.

6. CX Certificate—The CX certificate is the basis for the system's unique secured formation system, tailor-made for each website. It enables the system to disguise assets (e.g. advertisement elements) as physical elements of the website. The CX certificate results from the analysis continuously performed by the e-learn module, as will be described in detail below.

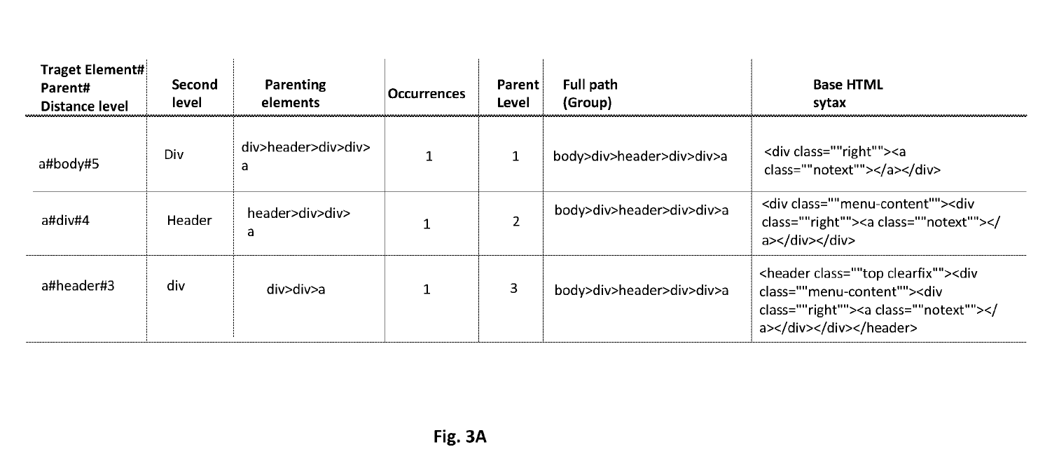

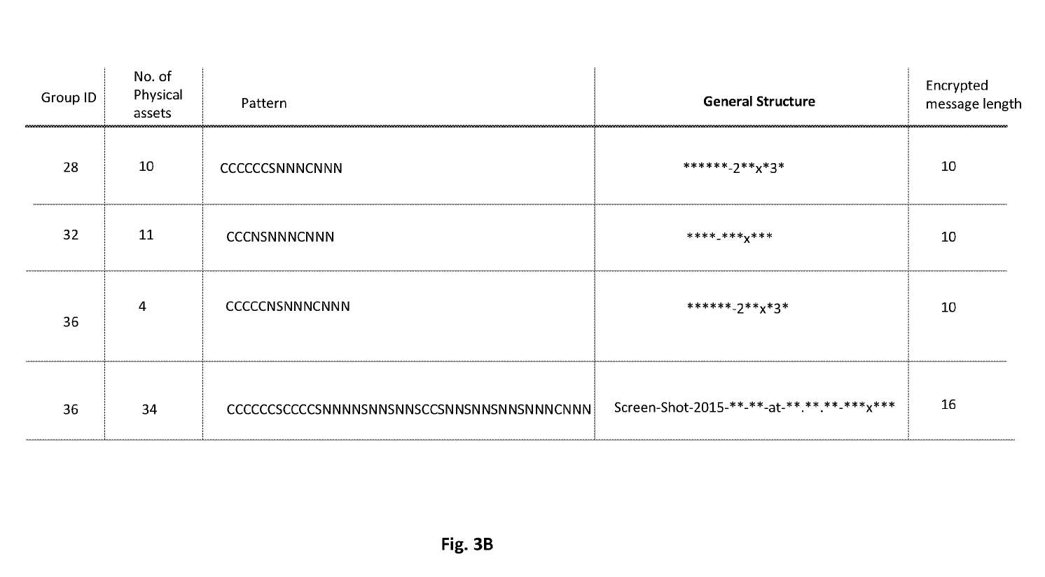

The CX certificate includes at least one of the following:
Structure patterns of the website's HTML elements and their nesting levels, such as shown for example in FIG. 3A.
Structure patterns of the website's physical assets, such as shown for example in FIG. 3B, into which the encrypted and/or scrambled messages are inserted.
A local character scrambling mechanism based on the encrypted value.
Various parameters.

The CX certificate may additionally comprise security elements. For example, in order to prevent cross domain script the system may add a Sandbox attribute to the asset's iframe.

The innovative solution is implemented as a method and system to serve encrypted and/or manipulated assets (such as a URL/Virtual Asset) as integrated ordinary website content, therefore, the abuse software i.e. asset blocking is not able to distinguish between the ordinary content and the asset. In order to do so, the solution combines the following methods:

HYBRID DYNAMIC SECURED ASSET SERVING PATH—Using the Block Detection Decision Mechanism, the method serves the asset at the optimal secured path.
SCAN & LEARN SYSTEM—creating a customized tailor-made Certificate for each website which reflects the nature of the website assets structure and HTML patterns.
UNIQUE CUSTOMIZED CERTIFICATE GENERATOR—A set of rules derived from analyzing the website's structures for creating undescernable virtual assets.
ENCRYPTION KEYS MECHANISM—Preventing asset blocking systems from decrypting the Virtual Asset messages.
DATA MANIPULATION PROCESS—Preventing asset blocking systems from identifing the data assets.
DYNAMIC SCRIPTS MECHANISM—Using the Scripts Manipulation Mechanism algorithm ensures that each served script will be unique.
BLOCKING LISTS ANALYSIS—One or more lists of elements and/or properties and/or domain/URL names that may be blocked. For example AdBlock's Easylist.

### System Components

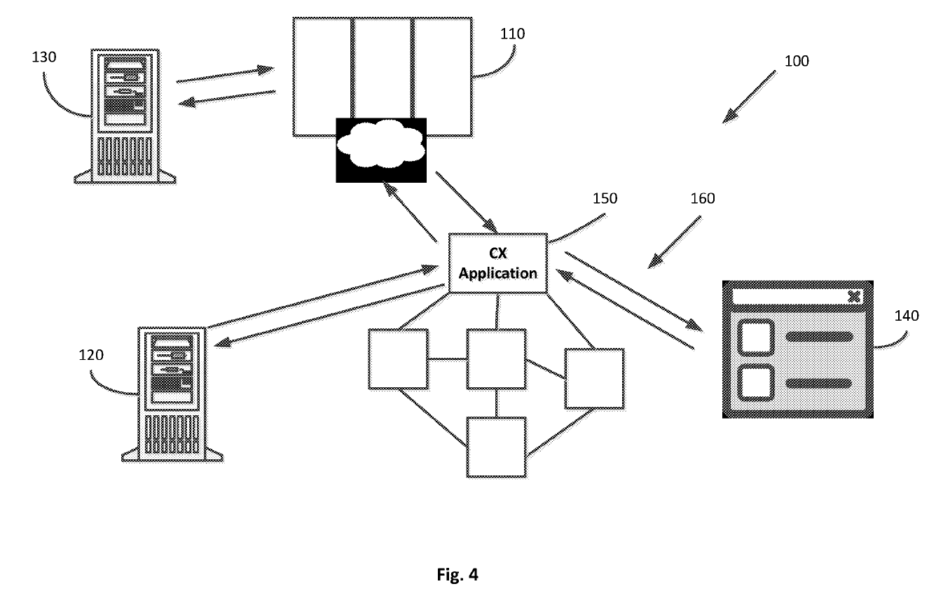

FIG. 4 is a schematic represntation of the system components and connections according to embodiments of the present invention.

The system 100 comprises:
At least one system server 110 running a server application comprising an e-learn module which dynamically creates and updates an asset block bypass package for each client (publisher), as will be explained in detail below. The system server may be a distributed server.
At least one publisher's content server 120
At least one 3^{rd} party asset serving system 130 (e.g. Ad Servers, Google Analytics (https://analytics.google.com/), Alexa (www.alexa.com/), etc.)
A plurality of user communication devices running an internet browser 140 communicating over the Internet with the CX application 150.
CX (system) application 150 running on an application server 160, communicating over the internet with the plurality of user communication devices running an internet browser 140, with the system server 110 and with the publisher's content server 120.

The application server 160 may be deployed at a CDN POPs servers, as depicted in FIG. 4. Alternatively, the application server 160 may reside between the CDN and the origin (publisher's content server) 120, or on a server which hosts the origin. In another embodiment the CX application may reside on the origin 120. In yet another embodiment the server application 160 may reside between the origin 120 and the user communication devices running an internet browser 140.

The CX application defines Asset Requests redirection rules for the CDN rules system (if applicable) or for itself.

In the following description we use the example of Ad assets. It will be understood that a similar method may be used for preventing other assets' blocking.

### Server Application

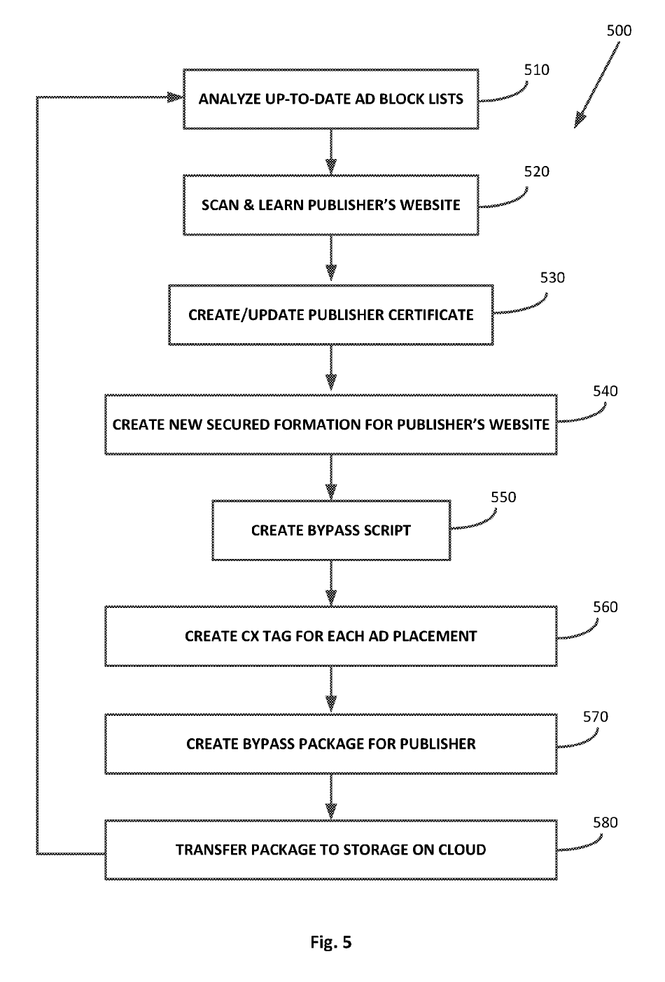

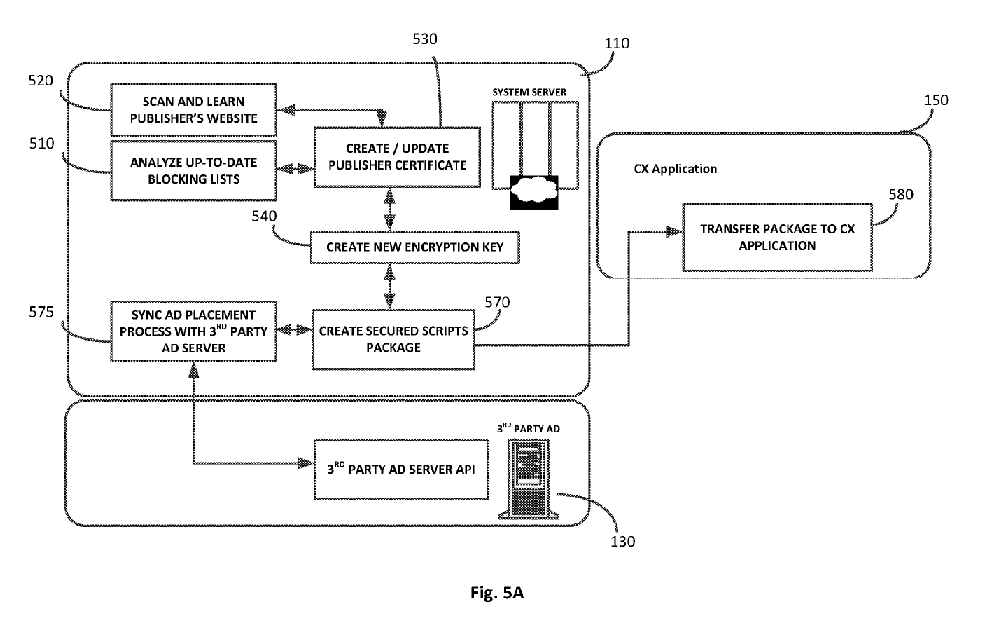

Attention is drawn to FIGS. 5 and 5A. FIG. 5 is a flowchart 500 showing the steps taken by the server application running on the system server 110.

The server application comprises at least an e-learn module, a web responder module e.g. Application program interface (API), and a synchronizer module.

e-Learn Module

1. Create Publisher's Certificate

The e-learn module running on the system server dynamically creates and updates a block bypass package for each client (publisher).

Attention is drawn to FIGS. 5 and 5A. FIG. 5 is a flowchart 500 showing the steps taken by the e-learn module. FIG. 5A is a block diagram showing the system modules performing the same steps according to embodiments of the invention.

In step 510 the e-learn module analyzes the most up-to-date blocking lists. These lists are continuously being updated by their owners for outsmarting bypass attempts. The system of the present invention subscribes to the lists, continuously identifies which old rules can still be applied and which new rules have been added, and creates/updates the system's blocking detection tests.

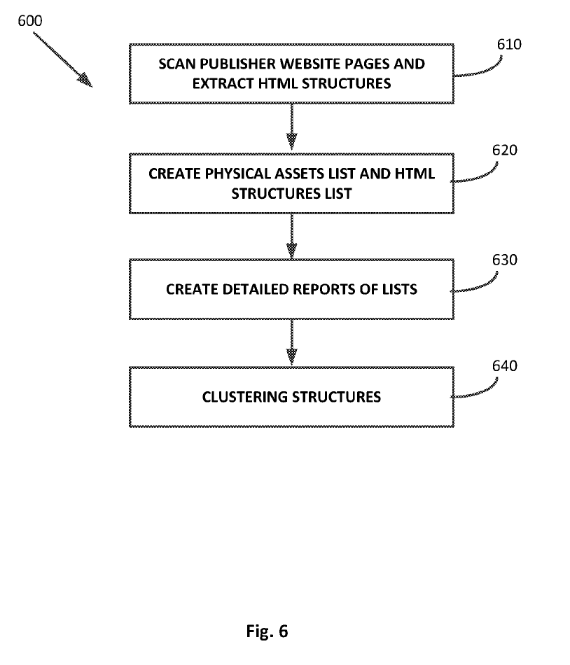

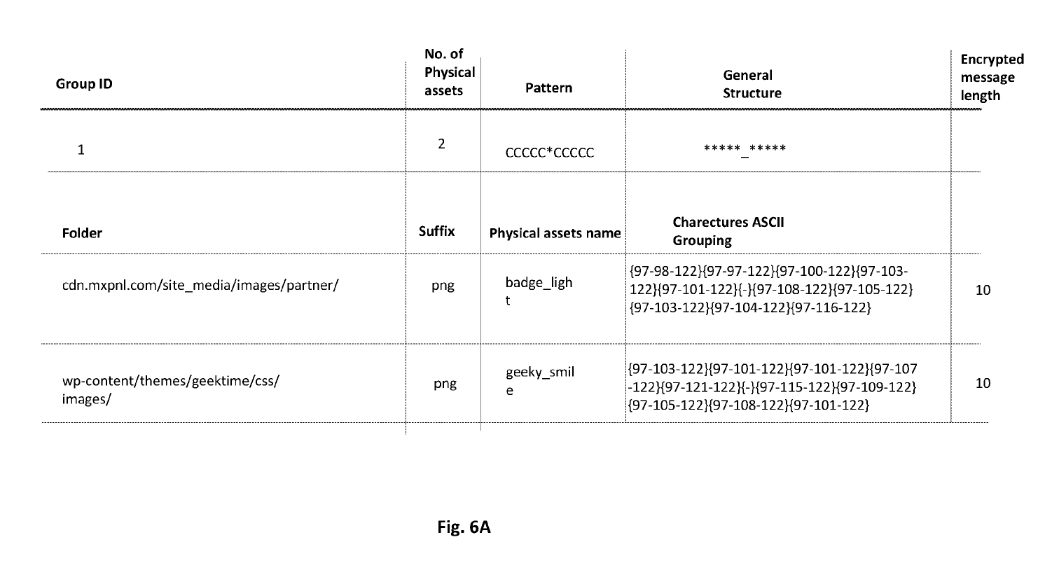

The system also uses the collected information to be used by other algorithms, such as for example page recovery, which identifies containers at risk of being blocked (e.g. by their name or structure) and create instructions to reconstructsor/and recovers them. In step 520 the e-learn module scans and learns the publisher website's HTML pages, as detailed in FIG. 6.

In step 530 the e-learn module creates/updates the publisher website's certificate from the previously detected structures. The certificate contains a set of rules and maps which represent the publisher's website profile including assets structure and behavior. The certificate also contains “cloaking” instructions specific to the publisher, based on his particular website's patterns.

The certificate is used by the system to create “cloaked” virtual assets, which are hard to distinguish from the rest of the page's physical assets.

In step 540 the e-learn module creates/updates the encryption key for the publisher's website.

2. Create Bypass Script

In step 550 a Bypass Script is created for the publisher's website, including a list containing instructions for cloaking the appropriate asset (e.g. Ad), which use a value encrypted by the newly created encryption key. In the example of bypassing Ad blocker, the cloaking instructions may be assigned to CX Tags. The Bypass Script may perform additional tasks such as creating a session cookie and sending statistical information to the system server.

In step 560, in the example of bypassing Ad blocker, a CX Tag(s) is created for each Ad placement in the publisher's website. This process is based on a separate synchronization process 575 in which the system requests the Ad Server 130 to provide all the Ad Placements for the current client (publisher).

The system server stores a variety of scripts for at least one of the following types:
I. Ad Block Detection.
II. CX Tag.

In order to avoid scripts detection by asset blockers, the system uses a Scripts manipulation algorithm module which, for example:
III. Modifies the scripts according to the website profile:
   Dynamic variables names changing.
   Line order scrambling.
   Minimizing the script.
IV. Ensures that each generated script is unique.

Each one of the CX Tags is constructed of at least one of HTML DOM container and/or a script

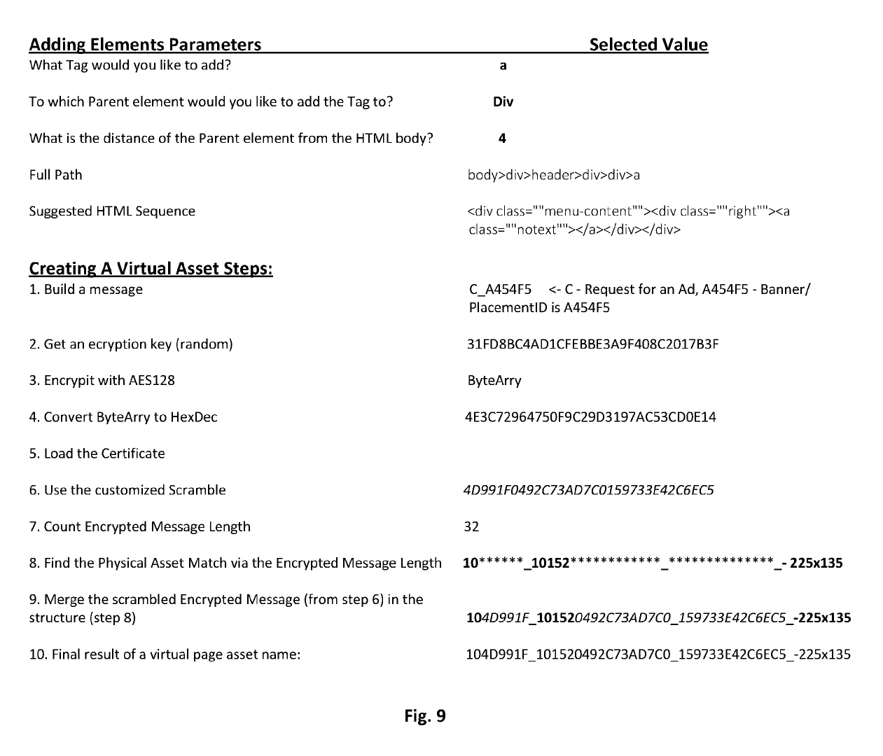

FIG. 9 shows exemplary non-limiting steps taken by the CX Tag script to create a secured formation asset:
1. Get request for an Ad including placement ID (or other type of Ad's asset request, such as: creative data i.e. image, video, tracking pixel URL, click URL etc.).
2. Get new or use existing encryption key.
3. Encrypt the Ad request.
4. Optionally Convert byte array to hexadecimal
5. Load to certificate.
6. Optionally Scramble.
7. Count encrypted message length.
8. Find matching physical asset structure.
9. Merge scrambled encrypted message into structure.
10. Get final virtual asset name.

1. Create Publisher's Package

In step 570 a unique package is created for the publisher's website, including the certificate, the secured formation, the Bypass Script and the CX Tags if needed, and in step 580 the package including an identification of the specific publisher is transferred to a storage on the cloud, from where it is retrieved by the CX application 150.

According to embodiments of the invention, the publisher's package may additionally include Ad Fraud Detection & Prevention scripts, for identifying fraudulent signals, including, for example, Real time protection mechanism using tests that tell with confidence whether the user viewing the ad is human or a machine:
Verify ad viewability
Verify human click

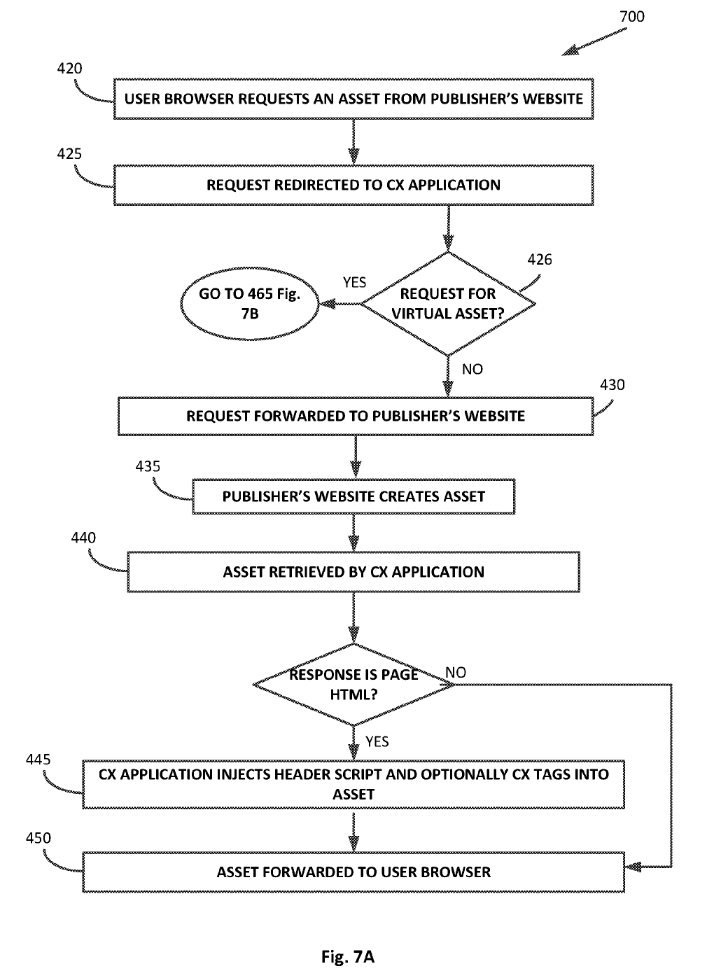

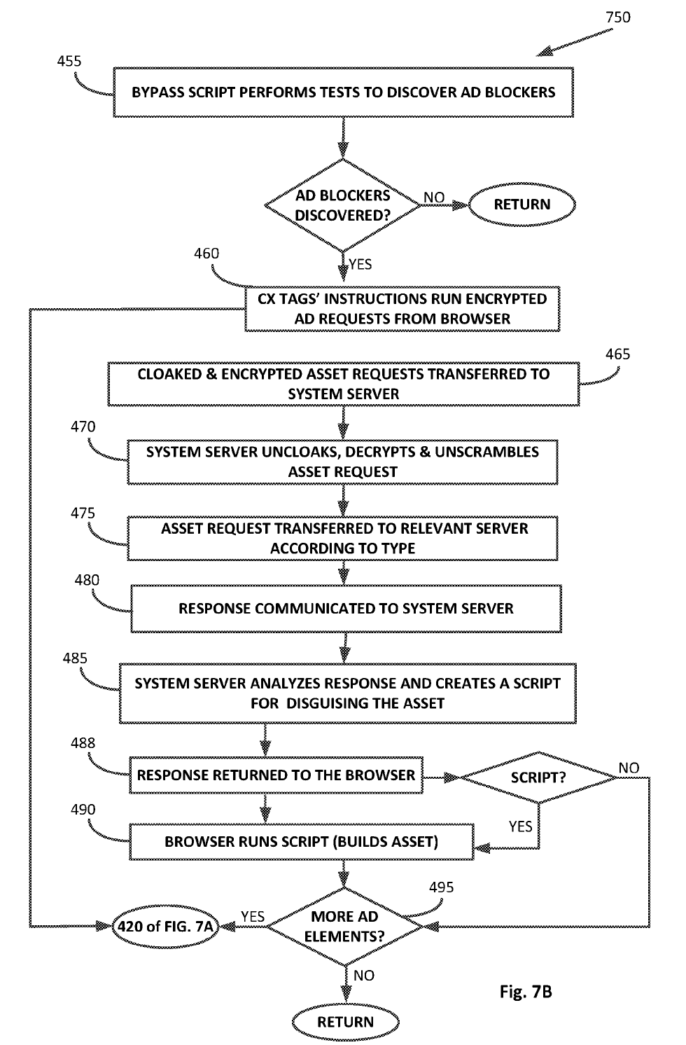

According to embodiments of the invention, some of the fraudulent signals identification scripts may be provided to the user's browser in real time, e.g. when creating an asset script (see step 485 in FIG. 7B).

In addition, some of the system anti-fraud identification may be derived from ongoing big data analysis results, such as for example:
Discrepancy between non-blockers and blockers performance.
Temporal pattern indicative of Bot activity.
Highly coordinated browsing.
Impression distribution by web page and user.

FIG. 6 is a flowchart 600 showing the steps taken by the scan & learn module.

In step 610 the scan & learn module scans, processes and analyzes the publisher website's pages and extracts HTML structures.

In step 620 the HTML structures are analyzed. The analysis includes measuring the nesting level between HTML elements and their hierarchy, detecting common structures and more.

At least two lists are created:
Website's physical assets list.
Website's HTML structures list.

In step 630 detailed reports are created for the two lists and in step 640 a novel clustering algorithm is deployed, using predefined parameters such as file length, file type etc., to find structure patterns for the HTML elements, as can be seen in the example of FIG. 3A and structure patterns of physical assets, as can be seen in FIG. 6A (Which leads to the result shown in FIG. 3B).

Abuse Advertising Software (e.g. Ad Block) Bypass

FIGS. 7A and 7B are flowcharts presenting the flow of data within the system of the present invention and the methods used for providing ad block bypass.

### Asset Request by Browser

FIG. 7A is a flowchart 700 showing the steps taken by the system once a registered publisher's asset is requested by a user's browser (step 420).

In step 425 the request is redirected to the CX application 150. If the request is for a virtual asset, the CX application 150 redirected the request to the system server 110 (Step 465, FIG. 7B).

Otherwise, if the request is for a non-virtual asset, namely a request created without the block bypass system's intervention, it is forwarded to the origin 120 (publisher's website) in step 430.

In step 435 the publisher's content server creates the asset and the asset is retrieved by the CX application (step 440).

If the asset is an HTML page, in step 445 CX application 150 injects into the page's HTML script the previously created Bypass Script, which comprises an Ad Block detection mechanism (if needed by the configuration) and optionally CX Tags and forwards the page to the requesting browser (step 450). The CX Tags will be injected into the page's HTML script if the page includes ads or if the request was for an ad or an ad element.

Otherwise, if the asset is not an HTML page, e.g. an image or some other ad element requested by the browser, the asset is forwarded to the requesting browser as is.

### Ad Block Detection

FIG. 7B is a flowchart 750 showing the steps taken by the Bypass Script contained in the HTML page once the user's browser loads the page received from the CX application 150.

According to embodiments of the invention, in step 455 the Block Detection mechanism incorporated in the injected Bypass Script performs a number of tests in order to estimate the likelihood of having an Ad Blocker entity at the end user side.

Alternatively, the system may deploy the secured asset policy regardless of the idendtification of an Ad Block, in which case the tests may be bypassed.

The tests are, for example:
Check if there is an open network connection to an Ad Serving asset (or semi ad system).
Build and analyze dummy HTML DOMs (Document Object Models) and/or manipulate their properties.

The tests are updated continuously by the e-learn module described above, to be compatible with the latest blocking lists.

If an Ad Blocker has been detected by the tests, the CX Tags scripts are triggered (if they exist) and each CX Tag runs asecured formation request for a specific Ad to be incorporated in a specified location on the page (Step 460) and the process returns to step 420 (FIG. 7A). Triggering the CX Tags may be done by the Bypass Script, or by the CX Tags themselves by querying the Bypass Script to find out whether they should be run.

### Web Responder Module (Secured Assets Creation)

In step 465 the secured formation asset requests are transferred to the system server 110 via the CX application 150. The system server uncloaks, decrypts and/or unscrambles them (step 470) as necessary, identifies the requested information according to the requested asset type (e.g. data, click, etc.) and if required communicates the decrypted asset requests to the appropriate server (step 475), optionally along with user parameters. The requested server responds by transferring to the system server 110 the generated response comprising for example a link to the asset's data, the asset's destination and more (step 480).

In step 485, if needed, the system server analyzes the response and generates a script for creating a disguised HTML that will represent the asset. A virtual asset is created for each ad element.

In step 488 the system server 110 returns the response to the browser, via the CX application 150. If the response is a script, in step 490 the browser runs the script, i.e. builds the asset. In step 495, if additional elements are missing from the ad, the browser sends another asset request to the CX application 150.

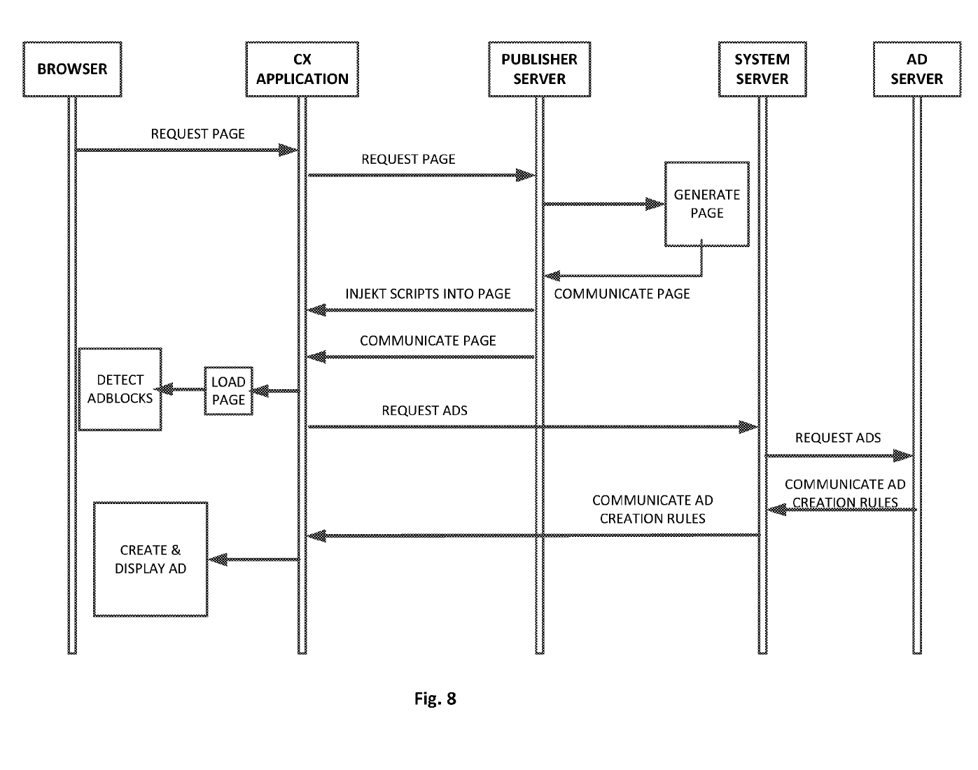

FIG. 8 is a chart presenting another view of the data flow described in conjunction with FIGS. 7A and 7B.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A system for bypassing 3^{rd} party request-blocking, comprising:
at least one system server running a server application;
at least one asset serving system communicating with said system server over the internet;
a system application running on an application server, said application server communicating over the internet with said system server;
at least one publisher's content server communicating over the internet with said system application; and
a plurality of user communication devices running an internet browser and communicating over the Internet with the system application,
said server application configured to continuously create and update a block bypass package comprising scripts comprising secured formations for said at least one publisher's web pages,
said system application configured to inject said scripts into said at least one publisher's web pages and to selectively redirect asset requests from said plurality of user communication devices' browsers to said at least one system server or to said at least one publisher's content server.

2. The system of claim 1, wherein said secured formations represent assets structures of said at least one publisher's website.

3. The system of claim 1, wherein said secured formations comprise at least one of encrypted messages, scrambled messages and cloaked messages.

4. The system of claim 1, wherein said scripts further comprise tests configured to detect the presence of 3^{rd} party request-blocking software in at least one of a user communication device, a user's browser, operation system (OS) and a user's network.

5. The system of claim 1, wherein said injected scripts comprise tags, said tags configured to send secured formation asset requests and receive instructions for creating said asset.

6. The system of claim 1, wherein said application server is deployed at a CDN (Content Delivery Network) POP (Point Of Presence) servers.

7. The system of claim 1, wherein said application server resides between a CDN and said at least one publisher's content server.

8. The system of claim 1, wherein said application server resides on a hosting level of said at least one publisher's content server.

9. The system of claim 1, wherein said application server resides between said at least one publisher's content server and said plurality of user communication devices.

10. A method of bypassing 3^{rd} party request-blocking, comprising:
providing at least one system server running a server application;
at least one 3rd party asset serving system communicating with said system server over the internet;
a system application running on an application server, said application server communicating over the internet with said system server; and
at least one publisher's content server communicating over the internet with said system application;
continuously creating and updating by said server application a block bypass package for said at least one publisher's website, said block bypass package comprising encryption keys and scripts comprising secured formations for said at least one publisher's web pages,
receiving by said system application a secured formation virtual asset request from a user's browser executing said at least one publisher's website;
using said publisher's block bypass package to regenerate an original asset request from said secured formation virtual asset request;
communicating said regenerated original asset request to a server;
receiving from said server and analyzing by said server application said requested original asset;
using said publisher's block bypass package to create a secured formation for said original asset; and
returning said created secured formation to said user's browser.

11. A method of bypassing 3^{rd} party request-blocking, comprising:
providing at least one system server running a server application;
at least one 3rd party asset serving system communicating with said system server over the internet;
a system application running on an application server, said application server communicating over the internet with said system server; and
at least one publisher's content server communicating over the internet with said system application;
continuously creating and updating by said server application a block bypass package for said at least one publisher's website, said block bypass package comprising encryption keys and scripts comprising secured formations for said at least one publisher's web pages,
receiving by said system application a physical asset request from a user's browser executing said at least one publisher's website;
retrieving by said system application said physical asset from said at least one publisher's content server; and
if said physical asset is an HTML (HyperText Markup Language) page, injecting scripts comprising secured formations for said at least one publisher's web pages to said HTML page.

12. The method of claim 10, wherein said continuously creating and updating by said server application a block bypass package for said at least one publisher's website comprises:
analyzing up-to-date blocking lists;
scanning and learning said at least one publisher's website;
creating/updating secured formation for said at least one publisher's website; and
creating a bypass script comprising at least one test for detecting 3^{rd} party request-blocking.

13. The method of claim 12, further comprising creating tags scripts configured to execute a request for a secured formation asset.

14. The method of claim 13, further comprising:
receiving by a user's browser an HTML page from said system application, said HTML page comprising said bypass script;
running said at least one test for detecting 3^{rd} party request-blocking; and
if said at least one test detects 3^{rd} party request-blocking, running said tags scripts.

15. The method of claim 11, wherein said continuously creating and updating by said server application a block bypass package for said at least one publisher's website comprises:
analyzing up-to-date blocking lists;
scanning and learning said at least one publisher's website;
creating/updating secured formation for said at least one publisher's website; and
creating a bypass script comprising at least one test for detecting 3^{rd} party request-blocking.

16. The method of claim 15, further comprising creating tags scripts configured to execute a request for a secured formation asset.

17. The method of claim 16, further comprising:
receiving by a user's browser an HTML page from said system application, said HTML page comprising said bypass script;
running said at least one test for detecting 3^{rd} party request-blocking; and
if said at least one test detects 3^{rd} party request-blocking, running said tags scripts.
